(19) United States
(12) Patent Application Publication
(10) Pub. No.: US 2006/0261195 A1
(43) Pub. Date: Nov. 23, 2006

(54) Wood chipper having an infeed chute safety device

(76) Inventor: Dennis A. Beam III, Shelby, NC (US)

Correspondence Address: KILPATRICK STOCKTON LLP, 1001 WEST FOURTH STREET, WINSTON-SALEM, NC, 27101, US

(21) Appl. No.: 11/496,318

(22) Filed: Jul. 31, 2006

Related U.S. Application Data
(63) Continuation-in-part of application No. 09/821,904, filed on Mar. 30, 2001, now Pat. No. 7,083,129.

(51) Int. Cl. B02C 25/00

(52) U.S. Cl. 241/37.5

(57) ABSTRACT

A waste reducing device, such as a wood chipper, can include an infeed chute, a powered feed system, a powered cutting system, a discharge chute, and a safety device including an elongated structure positioned outside of and adjacent to the infeed chute of the wood chipper. The elongated structure of the safety device can be movable vertically downward and radially inward towards the infeed chute between a plurality of positions. An actuator can be operably connected to the elongated structure and have a plurality of operable positions corresponding to the plurality of positions of the elongated structure. In various ones of the operable positions, the actuator can permit or stop motive operation of the powered feed and cutting systems of the wood chipper. The safety device can operate independently of a feed system control bar.

### CROSS REFERENCE TO RELATED APPLICATIONS

This application is a Continuation-in-Part application of, and claims the benefit of, co-pending U.S. patent application Ser. No. 09/821,904, filed on Mar. 30, 2001, which is incorporated by reference herein in its entirety.

### FIELD OF THE INVENTION

The present invention relates generally to a controlled feed device having an associated safety device and, more specifically, to a waste reducing device, such as a wood chipper, having an infeed chute safety device.

### BACKGROUND

Wood chippers are used to reduce branches, trees, brush, and other bulk wood products into small wood chips. A wood chipper typically includes an infeed chute, a feed system for controlling the feed rate of wood products into the chipper, a wood chipping mechanism, a drive system for powering the feed system and the chipping mechanism, and a discharge chute. The infeed chute is typically a funnel-shaped conduit with a wide opening which tapers towards the feed system, converging the wood products towards the chipping mechanism. Through the operation of the feed system, wood products are brought into contact with the chipping mechanism, which grinds, flails, or cuts the wood products into small pieces. These wood chips are propelled into the discharge chute and expelled from the wood chipper. Wood chippers, if operated incorrectly, are potentially dangerous devices. The chipping mechanism typically rotates at high speeds, producing the high torque necessary to chip wood products. The feed system, located at the narrowest point of the infeed chute, is a dangerous area which may catch an operator's clothing or, more importantly, an operator's limb if he or she improperly reaches into the infeed chute during operation of the wood chipper.

Existing wood chippers incorporate a number of safety devices designed to prevent such accidents and interrupt or reverse chipper motive operation should they occur. Such devices include, for example, warning labels, a safety bar which an operator may push, in the feed direction of the wood chipper, if he or she becomes caught by the feed system or cutting mechanism, and various cords/handles which hang inside the infeed chute. Although marginally effective, these safety devices suffer from the fact that their effectiveness is limited by the inattentiveness of an operator and that they are difficult to operate in an emergency situation.

### SUMMARY OF THE INVENTION

The present invention overcomes the aforementioned shortcomings and provides a wood chipper safety device that is effective and easy to operate in an emergency situation, thus preventing or minimizing operator injury. In one embodiment, a wood chipper safety device includes an elongated structure positioned outside of and adjacent to the infeed chute of a wood chipper. The elongated structure can be movable vertically downward between a plurality of positions. An actuator can be operably connected to the elongated structure and have a plurality of operable positions corresponding to the plurality of positions of the elongated structure. In various ones of the operable positions, the actuator can permit or stop motive operation of the powered feed and cutting systems of the wood chipper. The wood chipper includes a feed system control bar for controlling operation of the feed system. The safety device can operate independently of the feed system control bar.

In another embodiment, a waste reducing device, such as a wood chipper, having an infeed chute, a powered feed system, a powered cutting system, and a discharge chute includes an elongated structure positioned outside of and adjacent to the infeed chute of the waste reducing device. The elongated structure can be movable vertically downward between a plurality of positions. An actuator can be operably connected to the elongated structure and have a plurality of operable positions corresponding to the plurality of positions of the elongated structure. In various ones of the operable positions, the actuator can permit or stop motive operation of the powered feed and cutting systems of the waste reducing device. The waste reducing device includes a feed system control bar for controlling operation of the feed system. The safety device can operate independently of the feed system control bar.

As will be realized by those of skill in the art, many different embodiments of a wood chipper having an infeed chute safety device according to the present invention are possible. Additional uses, objects, advantages, and novel features of the invention are set forth in the detailed description that follows and will become more apparent to those skilled in the art upon examination of the following or by practice of the invention.

### BRIEF DESCRIPTION OF THE DRAWINGS

FIG. 1 is a perspective view of an embodiment of a wood chipper.

FIG. 2 is a cross-sectional side view of the infeed chute of the embodiment of the wood chipper shown in FIG. 1.

FIG. 3 is a side view of the infeed chute of the embodiment of the wood chipper shown in FIG. 1, incorporating an embodiment of a safety device according to the present invention.

FIG. 4 is a front view of the infeed chute of the embodiment of the wood chipper shown in FIG. 1, incorporating an embodiment of a safety device according to the present invention.

FIG. 5 is a side view of the infeed chute of the embodiment of the wood chipper shown in FIG. 1, incorporating another embodiment of a safety device of the present invention.

FIG. 6 is a front view of the infeed chute of the embodiment of the wood chipper shown in FIG. 1, incorporating an embodiment of another safety device according to the present invention.

### DETAILED DESCRIPTION

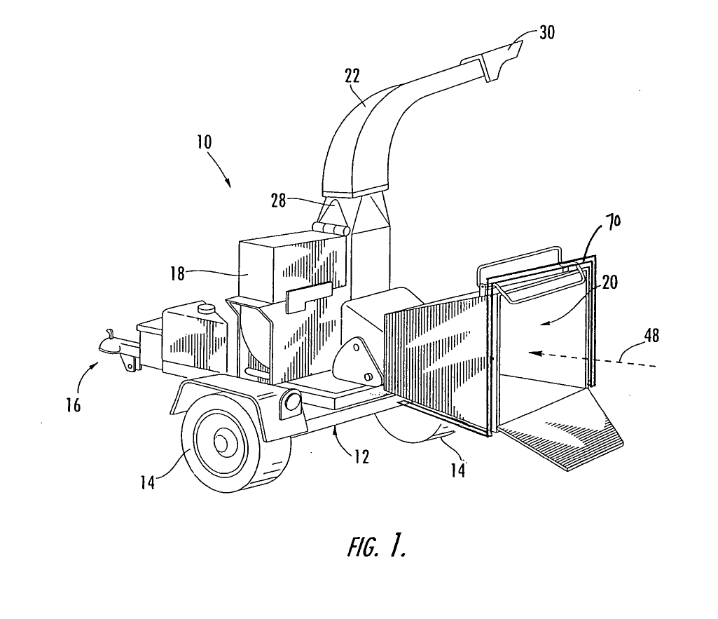

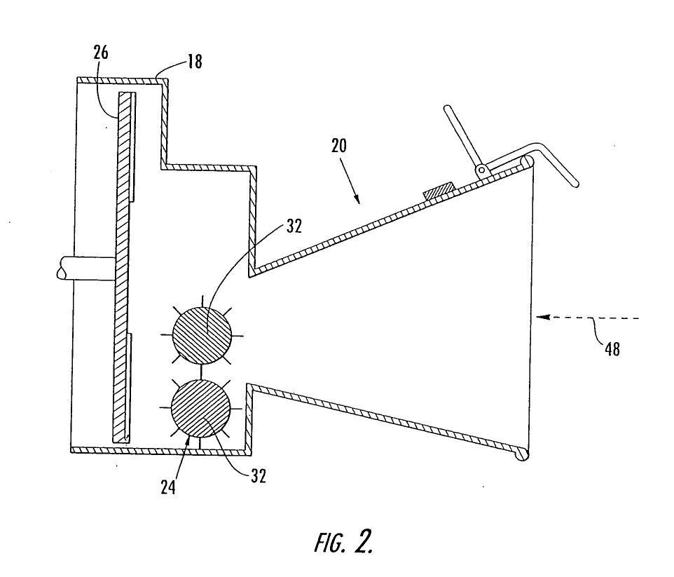

Referring to FIGS. 1 and 2, in one embodiment, a wood chipper 10 includes a frame 12 supported by a pair of wheels 14 and a conventional trailer hitch 16. The trailer hitch 16 allows the chipper 10 to be towed by a vehicle. A chipper hood 18, an infeed chute 20, and a discharge chute 22 are supported on the frame 12. An internal combustion engine may also be supported on the frame 12 for providing rotational energy to both a feed wheel system 24 and a cutting blade 26. The chipper hood 18 encloses the rotary cutting mechanism or blade 26 to prevent pieces of wood from exiting the wood chipper 10 at a high-velocity before being expelled through the discharge chute 22. A swivel bracket 28 may be mounted between the chipper assembly 18 and the discharge chute 22, allowing the discharge chute 22 to be to be rotatably aligned to expel wood chips in a desired direction. Additionally, the discharge chute 22 may include an adjustable deflector 30 mounted at the discharge chute exit for allowing further control over the direction of the exiting wood chip stream.

The internal combustion engine is generally operated such that the rotary cutting blade 26 rotates at a high velocity, while the feed wheels 32 rotate relatively slowly. In operation, branches, trees, brush, and other bulk wood products are fed into the infeed chute 20, in the feed direction 48, and captured between the opposed, rotating feed wheels 32. The wood products are thus advanced until they encounter the rotary cutting blade 26. The cutting blade 26 reduces the bulk wood products into chips which are expelled from the chipper 10 in a high-velocity air stream such that centrifugal force is imparted to the wood chips, driving them into the discharge chute 22. The wood chips enter the discharge chute 22 with sufficient linear velocity to be propelled an adequate distance from the wood chipper 10. Optionally, the swivel bracket 28 at the base of the discharge chute 22 and the deflector 30 at the exit of the discharge chute 22 may be adjusted to direct the exiting wood chip stream to a predetermined location away from the wood chipper 10.

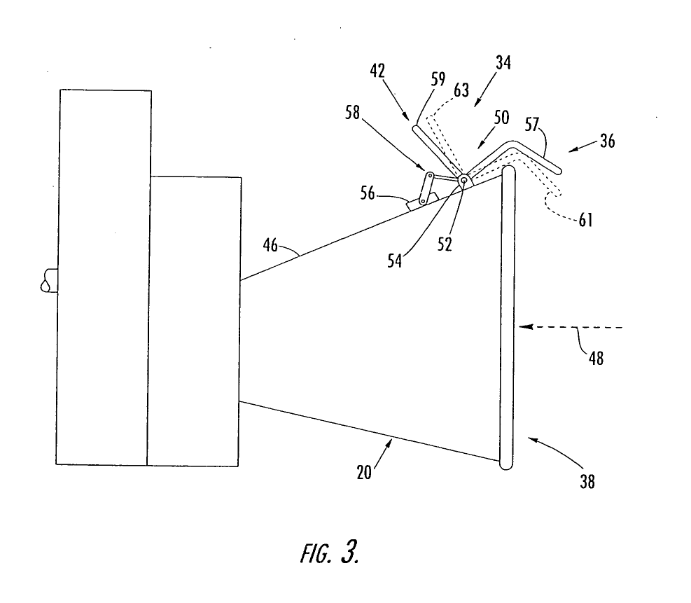

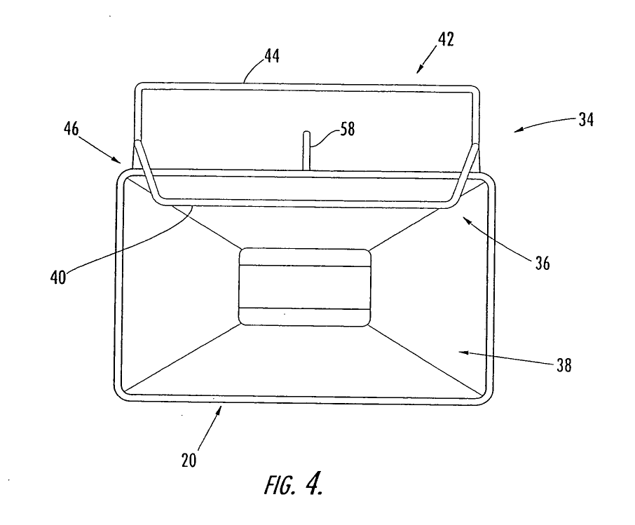

Referring to FIGS. 3 and 4, in one embodiment, the wood chipper safety device 34 of the present invention includes a first elongated structure 36, such as a bar, a rod, a handle, or a similar structure, positioned outside of and adjacent to the top of the opening 38 of the infeed chute 20. The first elongated structure 36 has a horizontally-extending portion 40 which extends substantially parallel to the upper portion of the opening 38 of the infeed chute 20, and in a spaced-apart relationship with the top 46 of the infeed chute 20. The first elongated structure 36 is movable vertically downward, and radially-inward towards the opening 38 of the infeed chute 20, between a plurality of positions. The second elongated structure 42 also has a horizontally-extending portion 44 which extends substantially parallel to, and in a spaced-apart relationship with, the top 46 of the infeed chute 20. The second elongated structure 42 is movable opposite the feed direction 48 of the wood chipper 10 (FIG. 1), and radially towards the opening 38 of the infeed chute 20, between a plurality of positions. The first elongated structure 36 may be rigidly attached to the second elongated structure 42 by means of a third elongated structure 50 positioned along the axis of rotation 52 of the first elongated structure 36 and the second elongated structure 42. The first elongated structure 36, the second elongated structure 42, and the third elongated structure 50 may be made of, for example, metal, plastic, or any other suitably rigid material. Alternatively, the first elongated structure 36 and the second elongated structure 42 may include a non-rigid but substantially non-extensible structure, such as a chain, cable, or rope. The third elongated structure 50 may be attached to the top 46 of the infeed chute 20 via one or more supports 54 that allow rotation, such as bearings or bushings and brackets. The bearings, bushings, and brackets 54 provide for independent or coordinated rotational movement of the first elongated structure 36 and the second elongated structure 42. The bearings, bushings, and brackets 54 may be made of, for example, nylon, plastic, metal, or any other suitable material.

The first elongated structure 36 and the second elongated structure 42 are operably connected to an actuator 56 which controls the powered feed and cutting systems of the wood chipper 10. Typically, these systems are hydraulically operated and controlled, however other operational systems may be utilized. The actuator 56 has a plurality of operable positions corresponding to the plurality of positions of the first elongated structure 36 and the second elongated structure 42. The actuator 56 may have a first operable position corresponding to a first position 57 (FIG. 3) of the first elongated structure 36 and a first position 59 (FIG. 3) of the second elongated structure 42, the first operable position of the actuator 56 permitting motive operation of the powered feed and cutting systems of the wood chipper 10. The actuator 56 may also have a second operable position corresponding to a second position of the first elongated structure 36 and a second position of the second elongated structure 42, the second operable position of the actuator 56 interrupting motive operation of the powered feed and cutting systems of the wood chipper 10. The actuator 56 may further have a third operable position corresponding to a third position 61 (FIG. 3) of the first elongated structure 36 and a third position 63 (FIG. 3) of the second elongated structure 42, the third operable position of the actuator 56 reversing motive operation of the powered feed and cutting systems of the wood chipper 10. Although three positions are discussed, there may be fewer or more positions but including a first, motive, position and one of a second stop or reverse position. As such, the elongated structures 36 and/or 42 may be rotated from a first position 57 and 59, which allows motive operation, to a third position 61 and 63, which reverses motive operation, with a second position that stops motive operation positioned there between. In this manner, an operator grabbing the first elongated structure 36 from within the infeed chute 20 simply pulls the first elongated structure 36 downward and rotationally inward, as would be the natural reaction of one trying to leverage oneself against the first elongated structure 36 to pull oneself out of the infeed chute 20. Similarly, an observer outside of the infeed chute 20 may push or pull the second elongated structure 42 rotationally inward, toward the opening 38 of the infeed chute 20 to stop or reverse the motive operation. Thus, by varying the position of the first elongated structure 36 and the second elongated structure 42, and thereby varying the operable position of the actuator 56, the operable state of the wood chipper 10 may be varied.

The first elongated structure 36 and the second elongated structure 42 may be operably connected to the actuator 56 via a linkage 58, such as one or more nylon, plastic, or metal bars or braces, which may, optionally, be notched at one or more ends. The linkage 58 is operable for holding the actuator valve 56 open, allowing hydraulic fluid to flow to the powered feed and cutting systems, permitting the motive operation of the wood chipper 10. As the first elongated structure 36 and the second elongated structure 42 are moved, the linkage 58 actuates the actuator 56 such that the flow of hydraulic fluid is interrupted or reversed, respectively interrupting or reversing the motive operation of the feed and cutting systems of the wood chipper 10. Alternatively, rather than utilizing a linkage, other mechanical, electrical, electro-mechanical, optical, magnetic, etc. devices may be utilized to sense the position of the elongated structures 36 and 42 and switch the operable position of the actuator valve 56 or other control associated with the feed and cutting systems of the wood chipper 10.

The first elongated structure 36 and the second elongated structure 42 are advantageously positioned to improve the operational safety of the wood chipper 10. The first elongated structure 36 is positioned relative to the infeed chute 20 such that an operator caught in the feed wheel system 24 and/or the cutting blade 26, especially one falling with a backwards motion, may readily grasp the horizontally-extending portion 40 of the first elongated structure 36 and pull vertically downwards and/or radially inwards towards the opening 38 of the infeed chute 20, stopping the motive operation of the wood chipper 10. The second elongated structure 42 is positioned relative to the infeed chute 20 such that an observer may readily grasp the horizontally-extending portion 44 of the second elongated structure 42 and push or pull opposite the feed direction 48 of the wood chipper 10 and/or radially inwards towards the opening 38 of the infeed chute 20, also stopping the motive operation of the wood chipper 10.

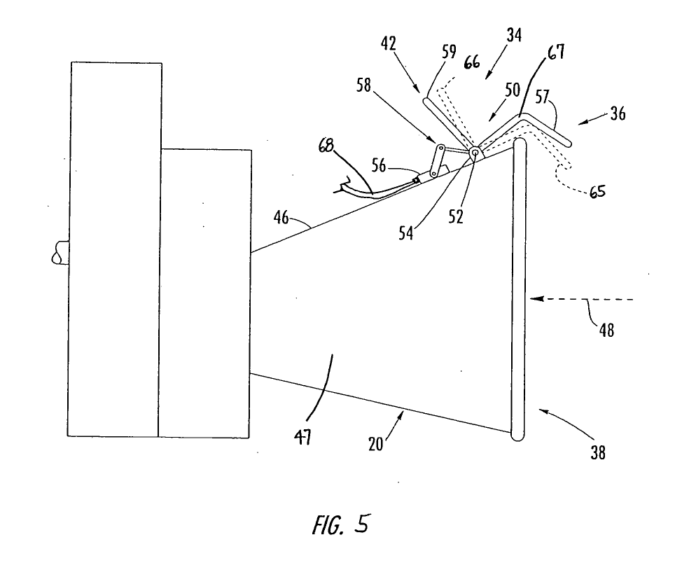

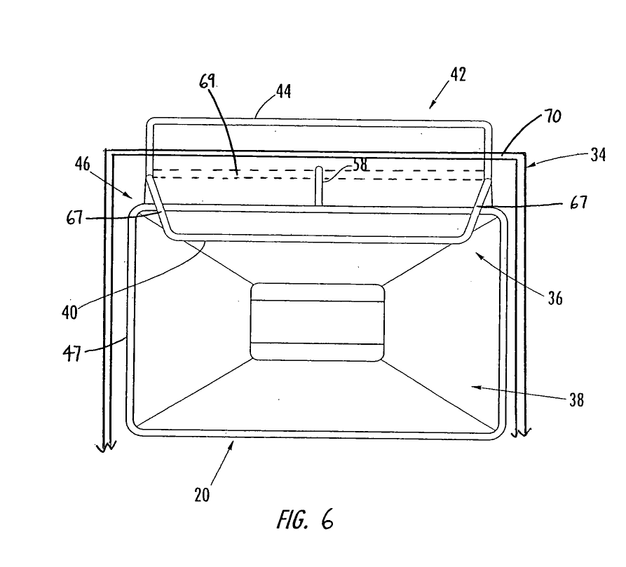

FIGS. 5 and 6 illustrate another embodiment of the safety device 34 of the wood chipper 10. In the embodiment shown in FIGS. 5 and 6, the wood chipper safety device 34 includes a first elongated structure 36, such as a bar, a rod, a handle, or a similar structure, positioned outside of and adjacent to the top of the opening 38 of the infeed chute 20. The first elongated structure 36 has a horizontally-extending portion 40 which extends substantially parallel to the upper portion of the opening 38 of the infeed chute 20, and in a spaced-apart relationship with the top 46 of the infeed chute 20. The first elongated structure 36 is movable vertically downward, and radially-inward, towards the opening 38 of the infeed chute 20, between a first position 57 and a second position 65. The second elongated structure 42 also has a horizontally-extending portion 44 which extends substantially parallel to, and in a spaced-apart relationship with, the top 46 of the infeed chute 20. As shown in FIG. 5, the second elongated structure 42 is movable opposite the feed direction 48 of the wood chipper 10, and is movable radially towards the opening 38 of the infeed chute 20, between a first position 59 and a second position 66.

The first elongated structure 36 may be rigidly attached to the second elongated structure 42 along the axis of rotation 52 of the first and second elongated structures 36, 42. The first elongated structure 36 and the second elongated structure 42 may be made of, for example, metal, plastic, or any other suitably rigid material. Alternatively, the first and second elongated structures 36, 42 may include a non-rigid and substantially non-extensible structure, such as a chain, cable, or rope. The first and second elongated structures 36, 42 may be attached to the top 46 of the infeed chute 20 via one or more supports 54 near each side 47 of the infeed chute 20. The supports 54, such as bearings or bushings and brackets, can allow rotation of the first and second elongated structures 36, 42. The bearings, bushings, and brackets 54 may be made of, for example, nylon, plastic, metal, or any other suitable material.

The safety device 34 can be positioned between the chipper operator and the feed wheel system 24. In an embodiment, the safety device 34 spans the width of the infeed chute opening 38, making it easier to access the device 34. The safety device 34 can be positioned so that it is highly visible outside the infeed chute 20, rather than being located within the infeed chute 20 where it may be hidden by brush or feed curtains. Accordingly, the safety device 34 may be activated outside of the infeed chute 20, so as to prevent placement of any part of the body into the infeed chute 20 in order to stop the feed wheel system 24.

The first elongated structure 36 and the second elongated structure 42 are operably connected to an actuator 56 which controls operation of the feed wheel system 24 and the cutting blade 26 of the wood chipper 10. In a preferred embodiment, the feed wheel system 24 and the cutting blade 26 are hydraulically operated and controlled. As shown in the embodiment in FIG. 5, the actuator 56 can be connected to one end of a hydraulic hose 68 that is operably connected on the opposite end to the feed wheel system 24 and the cutting blade 26. For example, the hydraulic hose 68 can be operably connected to an open-close valve (not shown) in the actuator 56. In alternative embodiments, other mechanisms, for example, electronic systems, may be utilized to operate and control the feed wheel system 24 and the cutting blade 26. The actuator 56 has a first operable position corresponding to the first positions 57, 59, respectively, of the first elongated structure 36 and the second elongated structure 42. In its first operable position, a mechanism, such as a pin, (not shown) in the actuator mechanically maintains the actuator valve open such that hydraulic fluid can flow from a hydraulic pump through the hydraulic hose 68 to the feed wheel system 24 and the cutting blade 26. Thus, in its first operable position, the actuator 56 can permit motive operation of the feed wheel system 24 and the cutting blade 26.

The actuator 56 has a second operable position corresponding to the second positions 65, 66, respectively, of the first elongated structure 36 and the second elongated structure 42. In its second operable position, the actuator 56 can mechanically reposition the pin (not shown) such that the actuator valve is closed and the flow of hydraulic fluid from a hydraulic pump through the hydraulic hose 68 is stopped. Thus, in its second operable position, the actuator 56 can immediately stop motive operation of the feed wheel system 24 and the cutting blade 26. Stopping motive operation of the feed wheel system 24 prevents further advancement of feed material or any other object into the feed wheel system 24 and into the cutting blade 26. Accordingly, the first and second elongated structures 36, 42, respectively, may be rotated from their first positions 57, 59, respectively, which allows motive operation of the feed wheel system 24 and the cutting blade 26, to their second positions 65, 66, respectively, in which motive operation of the feed wheel system 24 and the cutting blade 26 can be stopped. In this manner, an operator who grabs the first elongated structure 36 while facing the infeed chute 20, or from within the infeed chute 20, can simply push or pull the first elongated structure 36 downward and rotationally inward, as would be the natural reaction of one trying to leverage oneself against the first elongated structure 36 to pull oneself out of the infeed chute 20. Similarly, an observer outside of the infeed chute 20 may push or pull the second elongated structure 42 rotationally inward, toward the opening 38 of the infeed chute 20, to stop motive operation of the feed wheel system 24 and the cutting blade 26. Thus, by varying the position of the first elongated structure 36 and the second elongated structure 42, and thereby varying the operable position of the actuator 56, the operable state of the wood chipper 10 can be varied.

The safety device 34 can include a “lockout” mechanism to insure that it is safe to resume operations before the actuator 56 can again allow the flow of hydraulic fluid to operate the feed wheel system 24 and the cutting blade 26. For example, in one embodiment, once the pin is repositioned with the movement of the first and second elongated structures 36, 42, the actuator valve is closed to stop the flow of hydraulic fluid, and the motive operation of the feed wheel system 24 and the cutting blade 26 is stopped. Once the actuator valve has been closed, the interface between the actuator pin and valve must be reset, or realigned, in order for the first and second elongated structures 36, 42, respectively, to be moved back to their respective first positions 57, 59. In this way, the actuator valve can be re-opened only with an active step by an operator, rather than by merely returning the first and second elongated structures 36, 42, to their respective first positions 57, 59 to allow the flow of hydraulic fluid. This safety feature helps to eliminate any accidental reactivation of the hydraulic system and unintended re-powering of the feed wheel system 24 and the cutting blade 26. Thus, by assuring that the safety device 34 is operable prior to restarting the feed wheel system 24, the safety device 34 provides an additional level of safety to operation of the wood chipper 10.

The first elongated structure 36 and the second elongated structure 42 may be operably connected to the actuator 56 via a linkage 58, such as with one or more arms, as shown in FIG. 5. The linkage 58 is operable for holding the actuator valve 56 open, allowing hydraulic fluid to flow to the feed wheel system 24 and the cutting blade 26, permitting motive operation of the wood chipper 10. As the first elongated structure 36 and the second elongated structure 42 are moved to their respective second positions, 65, 66, the linkage 58 actuates the actuator 56 such that the flow of hydraulic fluid is interrupted, thereby stopping motive operation of the feed wheel system 24 and the cutting blade 26 of the wood chipper 10. Alternatively, rather than utilizing a linkage, other mechanical, electrical, electromechanical, optical, magnetic, or other mechanisms may be utilized to sense the position of the first and second elongated structures 36, 42 and switch the operable position of the actuator valve or other control associated with the feed wheel system 24 and the cutting blade 26 of the wood chipper 10.

The first elongated structure 36 and the second elongated structure 42 are advantageously positioned to improve the operational safety of the wood chipper 10. The first elongated structure 36 is positioned relative to the infeed chute 20 such that an operator caught in the feed wheel system 24 and/or the cutting blade 26, especially one falling with a backwards motion, may readily grasp the horizontally-extending portion 40 of the first elongated structure 36 and pull vertically downwards and/or radially inwards towards the opening 38 of the infeed chute 20, stopping the motive operation of the wood chipper 10. That is, in an emergency situation in which an operator may become panicked, all the operator must do to stop the feed wheels 32 is to grab the safety device 34 and pull it downward. The second elongated structure 42 is positioned relative to the infeed chute 20 such that an observer may readily grasp the horizontally-extending portion 44 of the second elongated structure 42 and push or pull opposite the feed direction 48 of the wood chipper 10 or radially inwards towards the opening 38 of the infeed chute 20, also stopping the motive operation of the wood chipper 10. Thus, the safety device 34 can be readily accessed from both the operator's position and from the direction of the wood chipper 10 engine, giving a person substantially 360 degrees from which to activate the safety device 34 outside the infeed chute 20. In this way, the safety device 34 can prevent both personal injury and equipment damage by providing a simple mechanism that can be readily accessed to instantly stop the feed wheel system 24.

The American National Standards Institute (ANSI) promulgated industry safety criteria for arborists in ANSI standard Z113. According to ANSI Z133, all controlled feed chippers are required to have a control bar (similar to the feed system control bar 70 shown in FIGS. 1 and 6) to control the feed system. Conventional wood chippers may rely on a feed system control bar as the only means to deactivate the feed system. Conventional feed system control bars often control operation of the feed system by positioning of the control bar in certain operative positions. For example, the control bar can be positioned to cause the feed wheels to rotate so as to pull feed material in a forward direction toward the cutting blade. The control bar may be moved to a neutral position that causes the feed wheels to stop rotating. By moving the control bar to yet another position, the feed wheels can be caused to operate in a reverse direction. To stop movement of the feed wheels, the control bar must be moved to the exact “neutral” position and not in either the “forward” or “reverse” positions, which may be difficult to achieve by an operator or other personnel in an emergency situation.

Because the feed system control bar 70 is used repeatedly, it can possibly become damaged or misaligned, which can affect the operation of the control bar 70. Relying on a single mechanism that may not operate effectively increases the risk that an operator or others may not be able to stop the feed wheel system 24 quickly, or at all, in case of an emergency. As shown in FIGS. 1 and 6, an embodiment of the present invention can include both the feed system control bar 70 and the safety device 34. An embodiment of the safety device 34 according to the present invention operates independently of the feed system control bar 70, and thus provides a safety mechanism for stopping the feed wheel system 24. The safety device 34 provides a redundant mechanism for stopping the feed wheel system 24 that is less used and more likely to operate properly.

Conventional wood chippers may include safety mechanisms that rely on electronic sensors or other electrical components that may require frequent adjustment to operate properly and/or may be prone to failure. In an embodiment of the present invention, the safety device 34 has the advantage of operating by utilizing a simple mechanical mechanism that does not involve electronic components. For example, the safety device 34 can act as a “lockout” mechanism by pulling, or otherwise moving, a pin to stop the flow of hydraulic fluid and thereby effectively prevent the wood shipper 10 engine from powering the feed wheel system 24 and cutting blade 26 until the pin is reset. As a result, the safety device 34 provides a quick, simple, active, and reliable mechanism to instantly stop the feed wheel system 24. Thus, the safety device 34 advantageously provides a means for reducing accidents during operation of the wood chipper 10.

In some embodiments of the present invention, the configuration and orientation of the safety device 34 can vary. As shown in FIG. 6, the first elongated structure horizontal portion 40 is connected to the supports 54 with an arm 67 on each end of the horizontal portion 40. In the embodiment shown in FIG. 6, the arms 67 are configured so as to orient inwardly toward the infeed chute opening 38. In an alternative embodiment (not shown), the arms 67 can be oriented outwardly so that the horizontal portion 40 of the first elongated structure 36 extends laterally beyond the infeed chute opening 38. In this configuration, the arms 67 of the safety device 34 can be accessed at the sides 47 of the infeed chute 20. The arms 67 can then be rotated downwardly between the infeed cute sides 47 and the control bar 70 to move the first and second elongated structures 36, 42, respectively, to their second respective positions 65, 66, to stop motive operation of the feed wheel system 24 and cutting blade 26.

In another embodiment, the safety device 34 can include a single elongated structure, for example, the first elongated structure 36, which can operate as described herein. In yet another embodiment, the safety device 34 can include three or more elongated structures, or bars, similar to the first and second elongated structures 36, 42. In such an embodiment, a third elongated structure 69 (as shown by the phantom lines in FIG. 6) can be connected to both the first and second elongated structures 36, 42, and to the supports 54 such that each of the elongated structures can rotate together about the axis of rotation 52. Alternatively, the safety device 34 can include other configurations, structures, and orientations about the infeed chute 20. For example, the horizontal portions of the elongated structures, for example, the horizontal portions 40 and 44 of the first and second elongated structures 36, 42, can include a non-rigid and substantially non-extensible structure, such as a chain, cable, or rope that can add further accessibility to the safety device 34. In other embodiments, the elongated structures, arms 67, and other components of the safety device 34 can be positioned above the feed system control bar 70. In such embodiments of the present invention, the safety device 34 is accessible to operators and others from both inside and outside the infeed chute 20.

The safety device 34 can be configured and positioned to reduce false activation by feed material entering the infeed chute 20 accidentally coming into contact with the device 34. Preferably, the safety device 34 is made of durable components to reduce damage from possible contact with feed materials, such as brush.

The safety device 34 can have a color distinct from other parts of the wood chipper 10, including the feed system control bar 70, to differentiate it from wood chipper 10 and the feed system control bar 70, thereby facilitating quick access and operation of the safety device 34. In one embodiment, the safety device 34 can be distinctly colored using a powder coating to increase the longevity of the distinct color on the safety device 34.

Although the present invention has been described with reference to preferred embodiments, other embodiments may achieve the same or similar results. Variations in and modifications to the present invention will be apparent to those skilled in the art. For example, the wood chipper 10 may include any suitable controlled feed or waste reducing machinery used to chip, grind, cut, or otherwise reduce bulk products. While the preferred embodiments incorporate opposed, horizontally-aligned feed wheels 32, any feed system 24 may be incorporated into the present invention, including a single feed wheel or opposed, vertically-aligned feed wheels. Additionally, while the preferred embodiments incorporate hydraulic systems, the wood chipper 10 and its feed and cutting systems may be powered by any other suitable means including, but not limited to, electricity, gas, or diesel power. The following claims are intended to cover all such equivalents.

What is claimed is:

1. A safety device for a waste reducing apparatus having an infeed chute, comprising:
a first elongated structure and at least a second elongated structure each positioned outside of and adjacent a top of the infeed chute, the first elongated structure movable radially towards an opening of the infeed chute, one of the at least second elongated structures movable opposite a feed direction of the waste reducing apparatus, each elongated structure movable between a first position that permits operation of the waste reducing apparatus and a second position that stops operation of the waste reducing apparatus; and
an actuator operably connected to the first and at least second elongated structures, the actuator having a first operable position corresponding to the first position of the first and at least second elongated structures and a second operable position corresponding to the second position of the first and at least second elongated structures.

2. The safety device of claim 1, the waste reducing apparatus further comprising a feed system and a control bar for controlling operation of the feed system, wherein the safety device is operable independently of the control bar.

3. The safety device of claim 1, further comprising a lockout mechanism that prevents the first elongated structure and the at least second elongated structure from returning from the second position to the first position without being reset.

4. The safety device of claim 3, wherein the lockout mechanism comprises a mechanically operated lockout mechanism.

5. The safety device of claim 4, wherein the lockout mechanism comprises a pull pin.

6. The safety device of claim 1, wherein the actuator further comprises a valve operably connected to a flow of hydraulic fluid, and wherein when the actuator is in the first operable position, the actuator permits the flow of hydraulic fluid, and when the actuator is in the second operable position, the actuator stops the flow of hydraulic fluid.

7. The safety device of claim 1, wherein each of the elongated structures is rigidly attached to each of the other elongated structures.

8. The safety device of claim 1, further comprising a linkage operably connecting the actuator to each of the elongated structures.

9. A safety device for a waste reducing apparatus having an infeed chute, comprising:
an elongated structure positioned outside of and adjacent a top of the infeed chute and movable radially towards an opening of the infeed chute, between a first position that permits operation of the waste reducing apparatus and a second position that stops operation of the waste reducing apparatus; and
an actuator operably connected to the elongated structure and having a first operable position corresponding to the first position of the elongated structure and a second operable position corresponding to the second position of the elongated structure.

10. The safety device of claim 9, the waste reducing apparatus further comprising a feed system and a control bar for controlling operation of the feed system, wherein the safety device is operable independently of the control bar.

11. The safety device of claim 9, further comprising a lockout mechanism that prevents the elongated structure from returning from the second position to the first position without being reset.

12. The safety device of claim 11, wherein the lockout mechanism comprises a mechanically operated lockout mechanism.

13. The safety device of claim 12, wherein the lockout mechanism comprises a pull pin.

14. The safety device of claim 9, wherein the actuator further comprises a valve operably connected to a flow of hydraulic fluid, and wherein when the actuator is in the first operable position, the actuator permits the flow of hydraulic fluid, and when the actuator is in the second operable position, the actuator stops the flow of hydraulic fluid.

15. The safety device of claim 9, further comprising a linkage operably connecting the actuator to the elongated structure.
